(19) United States
(12) Patent Application Publication
(10) Pub. No.: US 2025/0125490 A1
(43) Pub. Date: Apr. 17, 2025

(54) ALL-SOLID-STATE CELL

(71) Applicant: Toyota Jidosha Kabushiki Kaisha, Toyota-shi (JP)

(72) Inventor: Shinya SHIOTANI, Nagoya-shi (JP)

(73) Assignee: Toyota Jidosha Kabushiki Kaisha, Toyota-shi (JP)

(21) Appl. No.: 18/773,934

(22) Filed: Jul. 16, 2024

(30) Foreign Application Priority Data
Oct. 13, 2023 (JP) 2023-177592

(51) Int. Cl. H01M 50/449; H01M 10/0562; H01M 50/431

(52) U.S. Cl. CPC H01M 50/449; H01M 10/0562; H01M 50/431

(57) ABSTRACT

An all-solid-state cell using a deposition-dissolution reaction of metallic lithium as an anode reaction includes: an anode current collector, a first solid electrolyte layer, a second solid electrolyte layer, and a cathode active material layer in this order in a thickness direction. The first solid electrolyte layer contains a solid electrolyte phase containing a first solid electrolyte, and a metal phase containing at least one of the following: Sn, Mg, and Ag. A proportion of the metal phase in the first electrolyte layer is 2.50 vol % or less. The second solid electrolyte layer contains a second solid electrolyte and does not contain the metal phase.

### CROSS-REFERENCE TO RELATED APPLICATION

This application claims priority to Japanese Patent Application No. 2023-177592 filed on Oct. 13, 2023, incorporated herein by reference in its entirety.

### BACKGROUND

### 1. Technical Field

The present disclosure relates to all-solid-state cells.

### 2. Description of Related Art

An all-solid-state cell typically includes a solid electrolyte layer between a cathode active material layer and an anode active material layer. Cells using a deposition-dissolution reaction of metallic lithium as an anode reaction are known in the field of cells.

For example, Japanese Unexamined Patent Application Publication No. 2021-089814 (JP 2021-089814 A) discloses, as an all-solid-state cell using a deposition-dissolution reaction of metallic lithium as an anode reaction, a cell including an anode current collector, a lithium (Li) storage layer, a metal M layer, a solid electrolyte layer, and a cathode layer in this order.

### SUMMARY

All-solid-state cells using a deposition-dissolution reaction of metallic lithium as an anode reaction are advantageous in that the manufacturing process can be easily simplified and the energy density can be easily improved. This is because, in this type of all-solid state cell, a commonly used anode active material layer (layer containing anode active material particles that store and release Li) is usually not provided at the time of manufacturing the all-solid-state cell, and an anode active material layer (Li-containing layer) is formed by initial charge. Such all-solid-state cells using a deposition-dissolution reaction of metallic lithium as an anode reaction have room for further improvement in reducing the risk of a short circuit.

The present disclosure was made in view of the above circumstances, and a primary object of the present disclosure is to provide an all-solid-state cell with a reduced risk of a short circuit.

### First Aspect

An all-solid-state cell using a deposition-dissolution reaction of metallic lithium as an anode reaction includes:
an anode current collector, a first solid electrolyte layer, a second solid electrolyte layer, and a cathode active material layer in this order in a thickness direction.

The first solid electrolyte layer contains a solid electrolyte phase containing a first solid electrolyte, and a metal phase containing at least one of the following: tin (Sn), magnesium (Mg), and silver (Ag).

A proportion of the metal phase in the first solid electrolyte layer is 2.50 vol % or less. The second solid electrolyte layer contains a second solid electrolyte and does not contain the metal phase.

### Second Aspect

In the all-solid-state cell according to the first aspect, the proportion of the metal phase in the first solid electrolyte layers may be 0.10 vol % or more.

### Third Aspect

In the all-solid-state cell according to the first or second aspect, the first solid electrolyte and the second solid electrolyte may be sulfide solid electrolytes.

### Fourth Aspect

In the all-solid-state cell according to any one of the first to third aspects, the metal phase may contain at least Sn.

### Fifth Aspect

The all-solid-state cell according to any one of the first to fourth aspects may further include a metal layer between the anode current collector and the first solid electrolyte layer. The metal layer may include an Mg layer and an Sn layer in this order from the anode current collector side.

The present disclosure is advantageous in that it can provide an all-solid-state cell with a reduced risk of a short circuit.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic cross-sectional view illustrating an all-solid-state cell according to the present disclosure.

### DETAILED DESCRIPTION OF EMBODIMENTS

Hereinafter, an all-solid-state cell according to the present disclosure will be described in detail with reference to the drawings. The drawings shown below are schematically shown, and the size and shape of each part are appropriately exaggerated for ease of understanding.

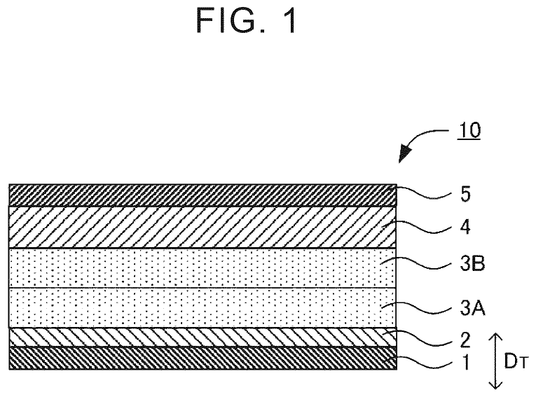

FIG. 1 is a schematic cross-sectional view illustrating an all-solid-state cell according to the present disclosure. The all-solid-state cell 10 illustrated in FIG. 1 includes the anode current collector 1, the metal layer 2, the first solid electrolyte layer 3A, the second solid electrolyte layer 3B, the cathode active material layer 4, and the cathode current collector 5 in this order in the thickness direction DT. The first solid electrolyte layer 3A includes a solid electrolyte phase including a first solid electrolyte, and a metal phase including at least one of Sn, Mg and Ag. The proportion of the metal phase in the first solid electrolyte layer 3A is 2.50 vol % or less. The second solid electrolyte layer 3B contains the second solid electrolyte and does not contain the metal phase.

According to the present disclosure, in a cell using a deposition-dissolution reaction of metallic lithium as an anode reaction, since the first solid electrolyte layer contains a predetermined proportion of a predetermined metal phase, an all-solid-state cell with a reduced risk of a short circuit is obtained.

Sn, Mg and Ag contained in the metal phase are both metals that can be alloyed with Li. Therefore, it is presumed that by using such a metal, dendrites can be trapped and the risk of a short circuit can be suppressed. In addition, since the metal phase dispersed in the first solid electrolyte layer has a high contact area with the first solid electrolyte, it is presumed that generation of a dendrite starting point can be suppressed. When the all-solid-state cell is charged, an alloy of the metal and Li is formed in the first solid electrolyte layer, and the resulting alloy functions as a protective layer that protects decomposition of the sulfide solid electrolyte. As a result, the cycle characteristics can be improved. On the other hand, if the proportion of the metal is too large, it is presumed that a fine short circuit is likely to occur.

Further, in the all-solid-state cell according to the present disclosure, the first solid electrolyte layer on the anode side contains the solid electrolyte phase and the metal phase, so that the area in which the solid electrolyte and the metal come into contact with each other on the anode side can be increased. As a result, an all-solid-state cell having good input characteristics (charge capacity) is obtained.

### 1. Anode Current Collector

Examples of the anode current collector include SUS, copper, nickel, and carbon. Examples of the shape of the anode current collector include a foil shape. The thickness of the anode current collector is, for example, 1 μm or more and 500 μm or less.

### 2. First Solid Electrolyte Layer

The first solid electrolyte layer contains at least a first solid electrolyte. The first solid electrolyte layer in the present disclosure contains a predetermined proportion of a predetermined metal phase.

The metal phase contains at least one of Sn, Mg and Ag. The metal phase may contain only one of Sn, Mg, and Ag, or may contain two or more of Sn, Mg and Ag. The metal phase preferably contains at least Sn. In the metal phase, Sn, Mg and Ag may each be present as a single substance or as an alloy. Examples of the alloy include a Li—Sn alloy, a Li—Mg alloy, and a Li—Ag alloy.

The proportion of the metal phase in the first solid electrolyte layer is 2.50 vol % or less, may be 2.44 vol % or less, may be 2.00 vol % or less, and may be 1.50 vol % or less. On the other hand, the proportion of the metal phase is, for example, 0.05 vol % or more, may be 0.10 vol %, may be 0.12 vol % or more, may be 0.20 vol % or more, may be 0.50 vol % or more. The proportion of the metal phase can be calculated, for example, from elemental mapping by scanning electron microscopy energy-dispersive X-ray spectroscopy (SEM-EDX).

In the first solid electrolyte layer, the metal phase is usually dispersed. The first solid electrolyte layer may have a sea-island structure in which the solid electrolyte phase containing the first solid electrolyte is sea and the metal phase is island. The solid electrolyte phase may contain a binder described later in addition to the first solid electrolyte. The average size (average diameter) of the metal phase is, for example, 10 μm or less, may be 5 μm or less, may be 3 μm or less, or may be 1 μm or less. On the other hand, the size of the metal phase is, for example, 0.01 μm or more.

The first solid electrolyte layer contains a first solid electrolyte. Examples of the first solid electrolyte include inorganic solid electrolytes such as sulfide solid electrolytes, oxide solid electrolytes, and halide solid electrolytes; and organic solid electrolytes such as polymer electrolytes and gel electrolytes. The sulfide solid electrolyte preferably contains sulfur(S) as a main component of the anionic element. The oxide solid electrolyte preferably contains oxygen (O) as a main component of the anionic element. The 10 halide solid electrolyte preferably contains halogen (X) as a main component of the anion. Among these, a sulfide solid electrolyte is preferable.

The sulfide solid electrolyte may be a glass-based (amorphous-based) sulfide solid electrolyte, a glass-ceramic-based sulfide solid electrolyte, or a crystalline sulfide solid electrolyte. Examples of the crystalline phase contained in the sulfide solid electrolyte include a LGPS crystalline phase, a Thio-LISICON crystalline phase, and an argyrodite crystalline phase.

Examples of the sulfide solid electrolyte include Li₂S—P₂S₅, Li₂S—P₂S₅—LiI, Li₂S—P₂S₅—GeS₂, Li₂S—P₂S₅—Li₂O, Li₂S—P₂S₅—Li₂O—LiI, Li₂S—P₂S₅—LiI—LiBr, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, and Li₂S—P₂S₅—ZₘSₙ (where m, n are positive numbers and Z is any one of Ge, Zn, and Ga). Other examples of the sulfide solid electrolyte include Li₂S—GeS₂, Li₂S—SiS₂—Li₃PO₄, and Li₂S—SiS₂—LixMOy (where x, y are positive numbers and M is any one of P, Si, Ge, B, Al, Ga, and In.

The first solid electrolyte layer may contain a binder. Examples of the binder include rubber-based binders such as butylene rubber (BR) and styrene-butadiene rubber (SBR), and fluoride-based binders such as polyvinylidene fluoride (PVDF). The thickness of the first solid electrolyte layer may be, for example, 1 μm or more, 10 μm or more, or 15 μm or more. On the other hand, the thickness of the first solid electrolyte layer is, for example, 100 μm or less, and may be 50 μm or less. As a method of forming the first solid electrolyte layer, for example, a method of implanting a metal into the solid electrolyte layer before pressing by a sputtering method is exemplified. The maximum value of the distance (distance in the thickness direction) from the reference surface to the metal phase is not particularly limited, but may be, for example, 1 μm or more, 3 μm or more, or 5 μm or more, with the surface of the first solid electrolyte layer on the anode current collector side as the reference surface.

### 3. Second Solid Electrolyte Layer

The second solid electrolyte layer is a layer containing a second solid electrolyte and not containing the metal phase. It can be seen from the elemental mapping by SEM-EDX that the second solid electrolyte layer does not contain a metal phase.

The second solid electrolyte layer usually contains a second solid electrolyte, and may further contain a binder. The second solid electrolyte is the same as the first solid electrolyte layer described in “2. First Solid Electrolyte Layer.” The binder is also the same as the binder described in “2. First Solid Electrolyte Layer.” The second solid electrolyte layer and the first solid electrolyte layer are preferably disposed so as to be in direct contact with each other. In this case, the interface between the first solid electrolyte layer and the second solid electrolyte layer is preferably present.

### 4. Cathode Active Material Layer

The cathode active material layer contains at least a cathode active material. The cathode active material layer may contain at least one of the following: a solid electrolyte, a conductive material, and a binder.

Examples of the cathode active material include an oxide active material. Examples of the oxide active material include rock salt-type layered active materials such as LiCoO₂, LiNi_{1/3}Co_{1/3}Mn_{1/3}O₂, spinel-type active materials such as LiMn₂O₄, Li₄Ti₅O₁₂, and olivine-type active materials such as LiFePO₄. Examples of the shape of the cathode active material include particulate. The mean particle diameter (D₅₀) of the cathode active material is, for example, 0.5 μm or more and 50 μm or less. The mean particle size (D₅₀) refers to the volume cumulative particle size measured by a laser diffractive scattering-particle sizing instrument.

Examples of the conductive material include a carbon material. Examples of the carbon material include particulate carbon materials such as acetylene black (AB) and Ketjen black (KB); and fibrous carbon materials such as carbon fibers, carbon nanotubes (CNT), and carbon nanofibers (CNF). The solid electrolytes and binders are the same as the solid electrolytes and binders described in “2. First Solid Electrolyte Layer.” The thickness of the cathode active material layer is, for example, 1 μm or more and 500 μm or less.

### 5. All-Solid-State Cell

The all-solid-state cell may have a metal layer between the anode current collector and the first solid electrolyte layer. The metal layer is a layer composed of at least one of a single metal and an alloy. The metal is not particularly limited as long as it can be alloyed with Li, but preferably contains at least Mg.

The metal layer is, for example, a thin film, and is preferably a vapor-deposited film. The thickness of the metallic layers is not particularly limited, but is, for example, 30 nm or more. On the other hand, the thickness of the metallic layers may be, for example, 2000 nm or less, or 1500 nm or less. The metal layer can be formed by, for example, a vapor deposition method such as vacuum deposition.

The metallic layers may not contain Li and may contain Li. The former corresponds to, for example, the state of the metal layer in the all-solid-state cell before the initial charging, and the latter corresponds to, for example, the state of the metal layer in the all-solid-state cell after the initial charging. When Li is introduced into the metal layer by the initial charge, the metal contained in the metal layer is alloyed with Li. As a result, an alloy phase such as a Mg—Li alloy phase is formed in the metal layer. On the other hand, during discharging, Li moves from the metal layer alloyed with Li toward the cathode. In addition, a Li phase may be formed inside the metal layer. In addition, a deposited Li layer may be formed between the metal layer and the first solid electrolyte layer. Further, a deposited Li layer may be formed between the metallic layer and the anode current collector.

The metal layer may be a single layer or a layer in which a plurality of layers is stacked. The metallic layer is preferably a layer composed of at least one of a Mg metal (a single Mg) and a Mg alloy (an alloy containing Mg as a main component), a so-called Mg layer. It is preferable that Mg layer and Sₙ layer be disposed on a surface of Mg layer facing away from the surface of the anode current collector. In other words, the metallic layer preferably includes Mg layer and Sₙ layer in this order from the anode current collector side. Sₙ layers are composed of at least one of a Sₙ metallic material (a single Sn) and a Sₙ alloy (an alloy containing Sₙ as a main component).

The all-solid-state cell according to the present disclosure generally includes a cathode current collector that collects electrons of the cathode active material layer. Examples of the cathode current collector include SUS, aluminum, nickel, and carbon. Examples of the shape of the cathode current collector include a foil shape. The thickness of the cathode current collector is, for example, 1 μm or more and 500 μm or less.

In addition, the all-solid-state cell in the present disclosure may have an exterior body that accommodates the above-described members. Examples of the exterior body include a laminate-type exterior body and a case-type exterior body.

The use of the all-solid-state cell is not particularly limited, and examples thereof include a power supply of a vehicle. That is, in the present disclosure, it is also possible to provide a vehicle equipped with the above-described all-solid-state cell. Vehicles include, for example, hybrid electric vehicle (HEV), plug-in hybrid electric vehicle (PHEV), battery electric vehicle (BEV), gasoline-powered vehicles, and diesel-powered vehicles. In particular, the all-solid-state cell according to the present disclosure is preferably used for a driving power source for a hybrid electric vehicle (HEV), a plug-in hybrid electric vehicle (PHEV), or a battery electric vehicle (BEV). In addition, the all-solid-state cell may be used for a power source for a moving object (for example, a railway, a ship, or an aircraft) other than a vehicle, or may be used as a power source for an electric product such as an information processing apparatus.

Note that the present disclosure is not limited to the above-described embodiment. The above embodiments are illustrative, and anything having substantially the same configuration as, and having similar functions and effects to, the technical idea described in the claims of the present disclosure is included in the technical scope of the present disclosure.

### Example 1

### Preparation of Cathode

The cathode active material, the solid electrolyte, the conductive material, the binder, and the dispersion medium were added to a container made of polypropylene (PP) and stirred for 30 seconds using an ultrasonic dispersion device. The cathode active material is a NCA active material. The solid electrolyte is a Li₂S—P₂S₅ based sulfide solid electrolyte containing LiI. The conductive material is vapor-grown carbon fiber (VGCF). Binders are butyl butyrate solutions which contain 5 wt % of PVDF. The dispersion medium is butyl butyrate. The ultrasonic dispersing device is a UH-50 manufactured by S.M.T. The volume ratio of the cathode active material and the solid electrolyte was 75:25. Next, PP container was shaken with a shaker (TTM-1, manufactured by Shibata Science Co., Ltd.) for 30 minutes. Thus, a cathode slurry was obtained. The cathode slurry was applied onto a cathode current collector (Al foil) by a blade method using an applicator and allowed to dry naturally. Then, it was dried on a hot plate at 100° C. for 30 minutes. Thus, a cathode having a cathode current collector and a cathode active material layer was obtained.

### Preparation of Anode Current Collector

Mg was deposited on the anode current collector (Ni foil) to form Mg layers (thickness 1000 nm). Thus, an anode current collector having Mg layers was produced.

### Preparation of Electrolyte Layer Member

The solid electrolyte, binder and dispersion medium were added to the vessel and stirred for 30 seconds using an ultrasonic dispersing apparatus. The solid electrolyte is a Li₂S—P₂S₅ based sulfide solid electrolyte containing LiI. Binders are heptane solutions which contain 5 wt % of PVDF. The dispersion medium is heptane. The ultrasonic dispersing device is a UH-50 manufactured by S.M.T. Next, the container was shaken with a shaker (TTM-1, manufactured by Shibata Science Co., Ltd.) for 30 minutes. Thus, a solid electrolyte slurry was obtained. The solid electrolyte slurry was applied to a substrate (PET films) by a blade method using an applicator and allowed to dry naturally. Thus, two members each having a solid electrolyte layer on the base material were prepared. The first solid electrolyte layer was obtained by sputtering Sₙ so that the volume ratio of Sₙ to one of the electrolyte layers was 0.12 vol %. The members were bonded so that the first solid electrolyte layer and the other solid electrolyte layer (second solid electrolyte layer) were opposed to each other, and pressed at 7 ton/cm². After pressing, PET films were peeled off. Further, a Sₙ layer (thickness: 100 nm) was formed by depositing Sₙ on the first solid electrolyte layer. As a result, an electrolyte layer member including Sₙ layer, the first solid electrolyte layer, and the second solid electrolyte layer was obtained.

### Preparation of Cell for Evaluation

The anode current collector and the electrolyte layer member are respectively punched out with Φ14.5 mm. The anode current collector and the electrolyte layer member were stacked so that Mg layer and Sₙ layer were opposed to each other. Then, an anode punched out with Φ11.28 mm was placed so that a cathode active material layer and a second solid electrolyte layer face each other. A stack was thus obtained. A cathode terminal and an anode terminal were connected to the stack, and the laminated film was sandwiched and welded to seal the stack. The sealed stack was pressed at 392 MPa by cold isotropic pressing (CIP). Thereafter, the metal plate was restrained by 1 MPa pressure. A cell for evaluation was thus manufactured.

### Comparative Example 1

An electrolyte layer member and a cell for evaluation were prepared in the same manner as in Example 1, except that no Sn was sputtered on the pre-press solid electrolyte layer in the production of the electrolyte layer member.

### Examples 2 to 4 and Comparative Example 2

Cells for Evaluation were fabricated in the same manner as in Example 1, except that the electrolyte layer member was manufactured so that the proportion of Sn in the first solid electrolyte layer was the volume ratio shown in Table 1.

### Evaluation

### Cross-Sectional SEM Monitoring

The cells for evaluation obtained in Examples 1 to 4 and Comparative Example 2 were charged to 4.2 V in CCCV mode at 60° C. and 0.15 mA/cm² (0.03 mA/cm²cut). The cell after the charge was disassembled, cross-sectional processing was performed, and Sₙ in the first solid electrolyte layer was confirmed to be dispersed by SEM-EDX.

As a result of SEM-EDX, Sₙ was dispersed in the first solid electrolyte layer in all of the cells for evaluation.

### Evaluation of Input Characteristics

The resulting cells for evaluation were CC charged at 25° C., 3.0 V to 4.2V, and 3 mA/cm², and the obtained charge capacity was measured. The presence or absence of a short circuit was checked. The results are shown in Table 1.

TABLE 1

| | Proportion of Sn | Presence or absence | Charging capacity |
|---|---|---|---|
| | (Vol %) | of short circuit | (mAh) |
| Comparative | 0 | Y | — |
| Example 1 | | | |
| Example 1 | 0.12 | None | 1.88 |
| Example 2 | 0.25 | None | 1.91 |
| Example 3 | 0.50 | None | 1.75 |
| Example 4 | 2.44 | None | 1.55 |
| Comparative | 4.76 | Y | — |
| Example 2 | | | |

As shown in Table 1, in Comparative Examples 1 and 2, a short circuit occurred and the charge capacity could not be measured. On the other hand, in Examples 1 to 4, no short circuit occurred, and the charging capacity was also good. From this, it was confirmed that in the all-solid-state cell according to the present disclosure, the occurrence of a short circuit is suppressed and the charge capacity is also good.

What is claimed is:

1. An all-solid-state cell using a deposition-dissolution reaction of metallic lithium as an anode reaction, the all-solid-state cell comprising an anode current collector, a first solid electrolyte layer, a second solid electrolyte layer, and a cathode active material layer in this order in a thickness direction, wherein
the first solid electrolyte layer contains a solid electrolyte phase containing a first solid electrolyte, and a metal phase containing at least one of the following: Sn, Mg, and Ag,
a proportion of the metal phase in the first solid electrolyte layer is 2.50 vol % or less, and
the second solid electrolyte layer contains a second solid electrolyte and does not contain the metal phase.

2. The all-solid-state cell according to claim 1, wherein the proportion of the metal phase in the first solid electrolyte layers is 0.10 vol % or more.

3. The all-solid-state cell according to claim 1, wherein the first solid electrolyte and the second solid electrolyte are sulfide solid electrolytes.

4. The all-solid-state cell according to claim 1, wherein the metal phase contains at least Sn.

5. The all-solid-state cell according to claim 1, further comprising a metal layer between the anode current collector and the first solid electrolyte layer, wherein the metal layer includes an Mg layer and an Sn layer in this order from the anode current collector side.
